(19) United States
(12) Patent Application Publication
(10) Pub. No.: US 2009/0271593 A1
(43) Pub. Date: Oct. 29, 2009

(54) PATCHING DEVICE FOR PATCHING ROM CODE, METHOD FOR PATCHING ROM CODE, AND ELECTRONIC DEVICE UTILIZING THE SAME

(75) Inventors: Ting-Cheng Hsu, Hsinchu City (TW); Liang-Cheng Chang, Hsinchu County (TW); Hong-Kai Hsu, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/111,315

(22) Filed: Apr. 29, 2008

(51) Int. Cl. G06F 9/30; G06F 9/32

(52) U.S. Cl. 712/226; 712/233; 712/E09.016; 712/E09.077

(57) ABSTRACT

An electronic device comprising a ROM, a reprogrammable memory, a processor, and a patching device. The ROM stores a first function starting from a first address, the reprogrammable memory stores a second function starting from a second address, the patching device couples to the ROM and the reprogrammable memory, and the processor couples to the patching device. The patching device receives directive information from the processor and determines whether the processor is going to fetch the first function, and generates and returns a branch instruction to the processor when the processor is going to fetch the first function. After receiving the branch instruction, the processor executes the branch instruction to cause an unconditional jump to the second address and subsequently fetches the second function.

### BACKGROUND OF THE INVENTION

1. Field of the Invention

The invention relates to patching devices for patching ROM code, methods for patching ROM code, and electronic devices utilizing the same.

2. Description of the Related Art

Read-only memory (ROM) is usually used in electronic devices to store firmware. Because data stored in ROM cannot be modified, ROM malfunctions when there is an error in the firmware.

To overcome the problem, conventional techniques use a flash ROM to replace ROM. Flash ROM is non-volatile memory that can be electronically erased and reprogrammed.

However, flash ROM is much more expensive than ROM. For cost down, techniques capable of patching ROM code are required.

### BRIEF SUMMARY OF THE INVENTION

The invention provides patching devices for patching ROM code. The patching device comprises a storage unit, a comparing unit, a branch instruction generator and a multiplexer. The storage unit stores a source address and a destination address indicating the start of a flawed ROM function and the start of a patch function, respectively. The comparing unit compares an access address from a processor with the source address stored in the storage unit. The branch instruction generator generates a branch instruction for jumping from the access address to the destination address. The multiplexer has a first input terminal receiving an accessed instruction according to the access address, a second input terminal receiving the branch instruction, an output terminal coupled to the processor, and a control terminal receiving the comparison result of the comparing unit. The multiplexer outputs the accessed instruction when the access address does not match the source address, and outputs the branch instruction when the access address matches the source address.

The invention further discloses electronic devices comprising a ROM, a reprogrammable memory, a processor, and the aforementioned patching device. A patch function is stored to the reprogrammable memory by the processor to replace a flawed function in the ROM. The processor outputs an access address and accesses the ROM or the reprogrammable memory according to the access address. When detecting that the processor is going to access the flawed ROM function, the patching device provides the processor with a branch instruction to jump to the reprogrammable memory to access the patch function.

The invention further discloses methods for patching ROM code. The method stores the address of a flawed ROM function as a source address and stores the address of a patch function as a destination address. When the code in the ROM is processed, the method compares an access address outputted from a processor with the source address. When the access address matches the source address, the method generates a branch instruction for the processor to jump to the destination address and sends the branch instruction to the processor; otherwise an accessed instruction according to the access address is sent to the processor.

In another embodiment of the electronic device, the ROM stores a first function starting from a first address, the reprogrammable memory stores a second function starting from a second address, the patching device couples to the ROM and the reprogrammable memory, and the processor couples to the patching device. The patching device receives directive information from the processor and determines whether the processor is going to fetch the first function, and generates and returns a branch instruction to the processor when the processor is going to fetch the first function. After receiving the branch instruction, the processor executes the branch instruction to cause an unconditional jump to the second address and subsequently returns the second function.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates an embodiment of the invention;

FIG. 2 shows the format of branch instruction of ARM architecture;

FIG. 3 is a flowchart, showing an embodiment of the method of the invention; and

FIG. 4 is a schematic diagram illustrating exemplary operations by the described embodiments of the system and method.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

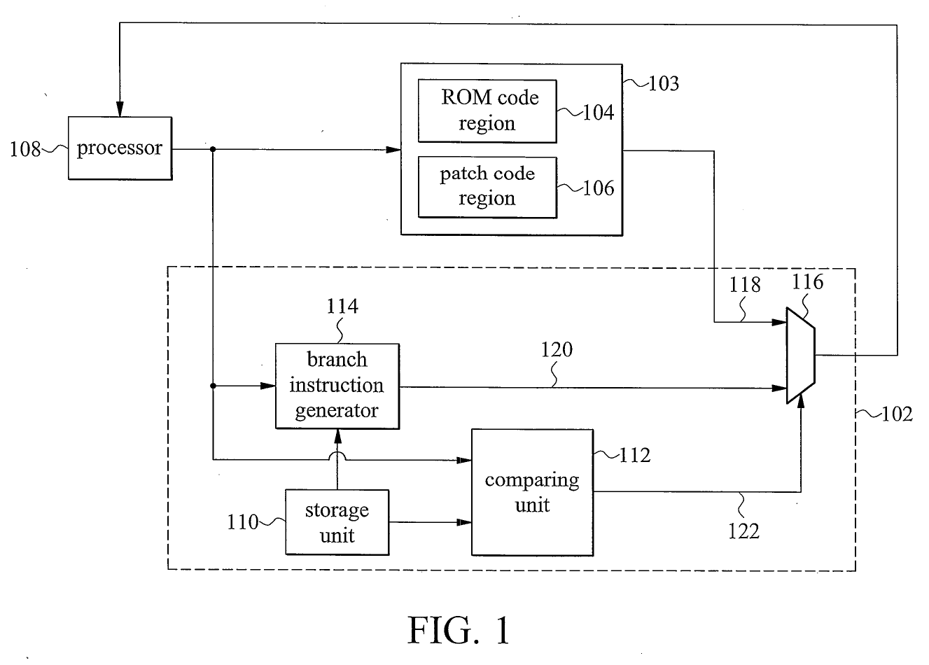

FIG. 1 illustrates the hardware architecture of an embodiment of system for patching read only memory (ROM) code, which comprises a patching device 102, a memory device 103 and a processor 108. The memory device 103 contains a memory controller (not shown in figure) and at least two storage regions: ROM code region 104 and patch code region 106. The ROM code region 104 stores multiple functions each may contain 32-bit (4-byte) instructions arranged in a continuous space. The patch code region 106 stores multiple functions each may contain 32-bit (4-byte) instructions arranged in a continuous space. The processor 108 accesses each instruction by its memory address. The processor 108 typically contains a program counter, which is a register indicating where the system is in its instruction sequence. The program counter holds the address of the next instruction to be executed. The program counter is automatically incremented, for example by 4, for each instruction cycle so that instructions are normally retrieved sequentially from the memory device 103. Certain instructions, such as branches and subroutine calls and returns, interrupt the sequence by placing a new value in the program counter. In this case, a function of the ROM code region 104 may comprise an error, referred to as a flawed ROM function. To replace the flawed ROM function, a patch function is provided in the patch code region 106.

Referring to FIG. 1, the patching device 102 comprises a storage unit 110, a comparing unit 112, a branch instruction generator 114 and a multiplexer 116. The instruction address of the flawed ROM function and the instruction address of the patch function 106 are stored in the storage unit 110 as a source address and a destination address, respectively. The storage unit 110 may be implemented in registers. There may be more than one flawed ROM functions in the ROM code region 104 so that multiple patch functions corresponding to the flawed ROM functions are required. The storage unit 110 may utilize various data structures to store the source addresses indicating the flawed ROM functions and the destination addresses indicating the patch functions, leading to each source address is mapped to a unique destination address. During fetching of an instruction to be executed, the processor 108 provides an access address to the memory controller of the memory device 103 and the branch instruction generator 114 and the comparing unit 112. To determine whether the processor 108 is going to access an instruction from the flawed ROM functions, the comparing unit 112 scans the source addresses of the storage unit 110 and determines whether the access address is present in the source addresses. The comparison result is sent to a control terminal of the multiplexer 116. The branch instruction generator 114 employs a similar way to determine whether the processor 108 is going to access an instruction of the flawed ROM functions. If so, the branch instruction generator 114 retrieves a destination address mapped by the discovered source address and generates a branch instruction according to the offset between the discovered source address and the retrieved destination address. Otherwise, no branch instruction is generated. Details of branch instruction generation are described in the following. The multiplexer 116 has two input terminals. One input terminal receives an accessed instruction 118 which is retrieved and provided by the memory controller of the memory device 103 according to the access address from the processor 108, and the other input terminal receives a branch instruction 120 generated by the branch instruction generator 114. It is to be understood that the generated branch instruction 120 is utilized to replace an access instruction of the flawed ROM function, as well as, after the branch instruction 120 is executed by the processor 108, an instruction of the patch function 106 indicated by the retrieved destination address is executed.

Based on the comparison result of the comparing unit 112, the multiplexer 116 sends the accessed instruction 118 or the branch instruction 120 to the processor 108. When the comparison result is that the access address matches one of the source addresses (meaning that the processor 108 is going to access an instruction of one of the flawed ROM functions), the multiplexer 116 is controlled to output the branch instruction 120 instead of the access instruction 118 to the processor 108, so that the program execution omits the flawed ROM function and jump to the corresponding patch function. When the comparison result is that the access address does not match any of the source addresses (meaning that the processor is going to access one of the correct ROM functions or one of the patch functions), the multiplexer 116 outputs the accessed instruction 118 to the processor 108.

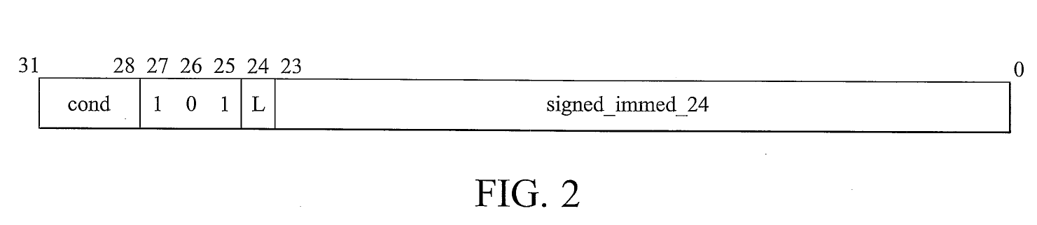

After receiving the access address, to generate the branch instruction 120, the branch instruction generator 114 accesses the storage unit to retrieve the destination address mapped by the access address (or matched source address) and calculates the offset between the destination address and the access address. The format of the branch instruction 120 may be shown in FIG. 2. For example, the branch instruction generator 114 calculates the content of signed_immed_24 by subtracting the access address and eight from the destination address and then rightward shifts the subtracting result by two bits.

In some embodiments, a portion of a reprogrammable memory is allocated as the patch code region 106. Electronic devices (such as shown in FIG. 1) comprising a processor 108, a ROM (containing the ROM code region 104), a reprogrammable memory (containing the patch code region 106) and a patching device 102 are within the scope of the invention. The processor 108 may load the patch code to the reprogrammable memory during booting-up of the electronic device and following, the pairs of source and destination addresses are stored into the storage unit 110.

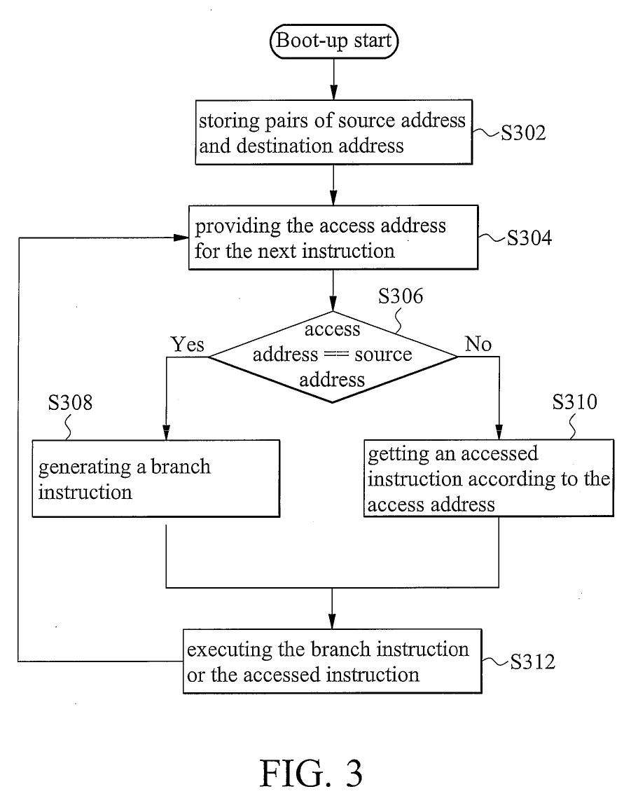

The invention further discloses methods for patching ROM code. FIG. 3 shows an embodiment of the method. In step S302, the method begins to store pairs of source and destination addresses into the storage unit (e.g. 110 of FIG. 1). A loop containing at least steps S304 to S312 is repeatedly performed to fetch instructions from ROM code and patch code regions and execute the fetched instructions. In step S304, an access address of the next instruction is provided by a processor (e.g. 108 of FIG. 1). The access address may be retrieved from a program counter of the processor. In step S306, the method compares the access address with all source addresses of a storage unit. When the access address matches one of the source addresses, step S308 is executed, in which a branch instruction utilized to cause an unconditional jump to a destination address mapped by the access (source) address is generated. When the access address does not match any of the source addresses, step S310 is executed, in which an instruction of the access address is accessed from a ROM function or a patch function in a memory device (e.g. 103 of FIG. 1). Then, in step S312, the accessed instruction or the generated branch instruction is executed and the method returns to step S304 to fetch the next instruction.

In some embodiments of the invention, the step of generating the branch instruction (S308) further comprises calculating the offset between the destination address and the access (source) address and encapsulating the calculated offset in the branch instruction.

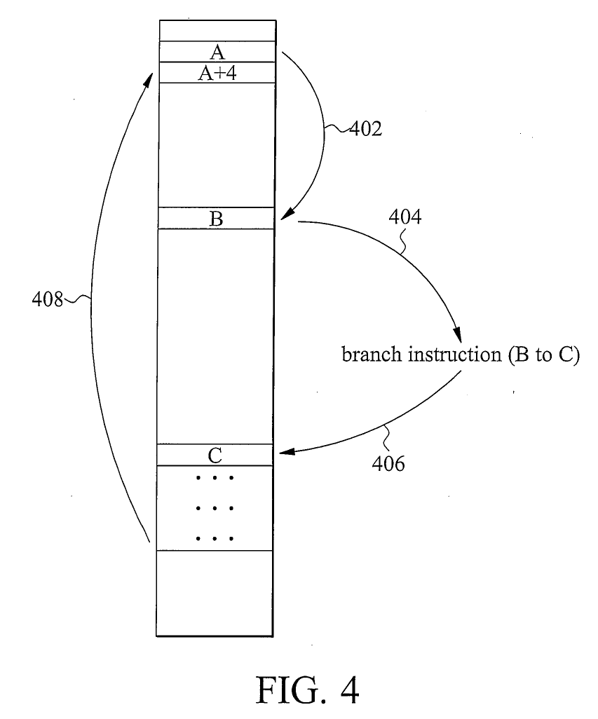

Details of the embodiments of the system and method illustrated in FIG. 2 and FIG. 3 are further provided in the following. FIG. 4 is a schematic diagram illustrating exemplary operations by the described embodiments of the system and method. The instructions in this embodiment may be 32-bits (4-bytes) instruction. A flawed ROM function may start from address B, and the corresponding patch function may start from address C. Address B and address C are initially stored in the storage unit 110 as the source address and the destination address. Assume that an instruction of an address A is branch-with-link instruction to cause a jump to the address B (arrow 402) and to be returned to an address A+4 (i.e. the next of the branch-with-link instruction).

Beginning from instruction of address A, the processor 108 fetches an instruction from the address A. After receiving directive information from the processor 108, the patching device 102 determines that the address A does not match any of source addresses stored in the storage unit 110 and returns the branch-with-link instruction of the address A to the processor 108. During execution of the returned branch instruction, the processor 108 first pushes an address of A+4 (i.e. increments the program counter by 4) into a stack or “link” register, calculates a jump address B according to the returned branch instruction, updates the program counter with the address B and directs the patching device 102 to return an instruction from the address B (arrow 402). After receiving the directive information from the processor 108, the patching device 102 determines that the address B matches a source address stored in the storage unit 110, retrieves the corresponding destination address C, generates a branch instruction containing the offset between the source address B and the destination address C and returns the generated branch instruction to the processor 108, where the branch instruction will cause a unconditional jump to the address C, (arrow 404). During execution of the returned branch instruction, the processor 108 calculates a jump address C according to the returned branch instruction, updates the program counter thereof with the address C and directs the patching device 102 to return an instruction from the address C (arrow 406). It is to be understood that, other than the execution of the branch-with-link instruction, the processor 108 does not push any address into the stack or “link” register as a return address during execution of the generated branch instruction. After receiving the directive information from the processor 108, the patching device 102 determines that the address C does not match any of source addresses stored in the storage unit 110 and returns an instruction of address C. After that, instructions of the patch function are sequentially compared with the source addresses by the patching device 102 and it is determined that the instructions do not match any of the source addresses. Thus, instructions of the patch function are fetched and executed by the processor 108 in sequence until the end of the patch function (i.e. a return instruction). During execution of the return instruction, the processor 108 pops out of the stack or “link” register to acquire the address A+4 and directs the patching device 102 to return an instruction from the address A+4 (arrow 408). Details of the subsequent instruction execution may be deduced by the analogy. It is to be observed that, with the disclosed embodiments of system and method, the flawed ROM function starting from address B is patched by the patch function starting from the instruction of address C.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A patching device for patching ROM code, comprising:
a storage unit, storing a source address indicating a flawed ROM code instruction and a destination address indicating a patch instruction;
a comparing unit, comparing an access address outputted from a processor with the source address stored in the storage unit;
a branch instruction generator, generating a branch instruction for jumping to the destination address; and
a multiplexer, having a first input terminal receiving an accessed instruction of the access address, a second input terminal receiving the branch instruction, an output terminal coupling to the processor, and a control terminal receiving the comparison result of the comparing unit,
wherein the multiplexer outputs the accessed instruction when the access address does not match the source address, and outputs the branch instruction when the access address matches the source address.

2. The patching device as claimed in claim 1, wherein the branch instruction generator calculates the offset between the destination address and the access address to generate the branch instruction.

3. An electronic device, comprising:
a read only memory (ROM);
a reprogrammable memory;
a processor, storing a patch instruction to the reprogrammable memory, and outputting an access address for accessing the ROM or the reprogrammable memory; and
a patching device, comprising:
a storage unit, storing a source address indicating a flawed ROM instruction and a destination address indicating the patch instruction;
a comparing unit, comparing the access address with the source address stored in the storage cell;
a branch instruction generator, generating a branch instruction for jumping to the destination address; and
a multiplexer, having a first input terminal receiving an accessed instruction accessed according to the access address, a second input terminal receiving the branch instruction, an output terminal coupling to the processor, and a control terminal receiving the comparison result of the comparing unit,
wherein the multiplexer outputs the accessed instruction when the access address does not match the source address, and outputs the branch instruction when the access address matches the source address.

4. The electronic device as claimed in claim 3, wherein the branch instruction generator generates the branch instruction based on the source address and the destination address.

5. A method for patching ROM code, comprising:
storing an address of a flawed ROM instruction as a source address and storing an address of a patch instruction as a destination address;
comparing an access address outputted from a processor with the source address;
generating a branch instruction for jumping to the destination address and sending the branch instruction to the processor when the access address matches the source address; and
sending an accessed instruction accessed according to the access address to the processor when the access address does not match the source address.

6. The method as claimed in claim 5, wherein the step of generating the branch instruction is based on the offset between the source address and the destination address.

7. An electronic device, comprising:
a read only memory (ROM) for storing a first instruction at a first address;
a reprogrammable memory for storing a second instruction at a second address;
a patching device coupling to the ROM and the reprogrammable memory; and
a processor, coupling to the patching device,
wherein the patching device generates and returns a branch instruction to the processor after receiving the directive information indicating returning of the first instruction from the processor, and the processor executes the returned branch instruction to cause an unconditional jump to the second address and subsequently directs the patching device to return the second instruction from the second address.

8. The electronic device as claimed in claim 7, wherein the patching device further comprises:
a branch instruction generator for calculating the offset between the first address and the second address and encapsulating the calculated offset in the branch instruction.

9. The electronic device as claimed in claim 8, wherein the patching device further comprises:
a storage unit storing at least one pair of a source address and a destination address, in which contains a pair of the first address and the second address,
wherein the branch instruction generator, coupling to the storage unit, retrieves the first and second addresses from the storage unit and generates the branch instruction based on the retrieved addresses.

10. The electronic device as claimed in claim 9, wherein the branch instruction generator further determines whether the first address matches one of the source addresses by scanning the source addresses and generates the branch instruction after determining that the first address matches one of the source addresses.

11. The electronic device as claimed in claim 7, wherein the patching device further comprises:
a storage unit for storing at least one pair of a source address and a destination address, in which contains a pair of the first address and the second address;
a branch instruction generator, coupling to the storage unit, for retrieving the first and second addresses from the storage unit and generating the branch instruction corresponding to the retrieved addresses;
a multiplexer, having a first input terminal coupling to the ROM and the reprogrammable memory for receiving the first instruction, a second input terminal coupling to the branch instruction generator for receiving the generated branch instruction, an output terminal coupling to the processor, and a control terminal; and
a comparing unit, coupling to the control terminal of the multiplexer and the storage unit, for receiving first directive information from the processor, which expects to fetch the first instruction from the first address of the ROM, determining whether the first address matches one of the source addresses by scanning the source addresses of the storage unit and controlling the multiplexer to output the generated branch instruction to the processor when determining that the first address matches one of the source addresses.

12. The electronic device as claimed in claim 11, wherein the branch instruction generator further calculates the offset between the first address and the second address and encapsulates the calculated offset in the branch instruction.

13. The electronic device as claimed in claim 7, wherein the processor directs the patching device to return the second instruction from the second address when executing the returned branch instruction, and the patching device retrieves the second instruction from the second address of the reprogrammable memory and returns the second instruction to the processor.

14. The electronic device as claimed in claim 13, wherein the patching device further comprises:
a storage unit storing at least one pair of a source address and a destination address, in which contains a pair of the first address and the second address; and
a branch instruction generator, coupling to the storage unit, for determining whether the first address matches one of the source addresses by scanning the source addresses, generating branch instruction after determining that the first address matches one of the source addresses, determining whether the second address matches one of the source addresses by scanning the source addresses, and generating no branch instruction after determining that the second address does not match any of the source addresses.

15. The electronic device as claimed in claim 13, wherein the patching device further comprises:
a storage unit for storing at least one pair of a source address and a destination address, in which contains a pair of the first address and the second address;
a branch instruction generator, coupling to the storage unit, for retrieving the first and second addresses from the storage unit and generating the branch instruction corresponding to the retrieved addresses;
a multiplexer, having a first input terminal coupling to the ROM and the reprogrammable memory for receiving the first instruction or the second instruction, a second input terminal coupling to the branch instruction generator for receiving the generated branch instruction, an output terminal coupling to the processor, and a control terminal; and
a comparing unit, coupling to the control terminal of the multiplexer and the storage unit, for receiving first directive information from the processor, which expects to fetch the first instruction from the first address of the ROM, determining whether the first address matches one of the source addresses by scanning the source addresses of the storage unit, controlling the multiplexer to output the generated branch instruction to the processor when determining that the first address matches one of the source addresses, receiving second directive information from the processor, which expects to fetch the second instruction from the second address of the reprogrammable memory, determining whether the second address matches one of the source addresses by scanning the source addresses of the storage unit; and controlling the multiplexer to output the second instruction to the processor when determining that the second address does not match any of the source addresses.
